(19) United States
(12) Patent Application Publication
(10) Pub. No.: US 2006/0151228 A1
(43) Pub. Date: Jul. 13, 2006

(54) Motor vehicle safety device for protecting pedestrians and cyclists

(75) Inventors: Ingo Kalliske, Potsdam (DE); Thomas Lube, Berlin (DE); Oliver Schmidt, Berlin (DE)

Correspondence Address: FOLEY AND LARDNER LLP;SUITE 500, 3000 K STREET NW, WASHINGTON, DC, 20007, US

(73) Assignee: Takata-Petri AG

(21) Appl. No.: 10/552,973

(22) PCT Filed: Aug. 26, 2004
(86) PCT No.: PCT/DE04/01895

§ 371 Date: Nov. 29, 2005

(30) Foreign Application Priority Data
Sep. 3, 2003 (DE) 103 41 368.5

(51) Int. Cl. B60R 21/34; B60K 28/10

(52) U.S. Cl. 180/274; 280/728.1

(57) ABSTRACT

A motor vehicle safety device for protecting pedestrians and cyclists includes at least one airbag that is connected to a gas generator arranged under the engine hood. The airbag is deployable to protect a pedestrian or a cyclist who strikes the vehicle. To prevent the lateral displacement of the segments of the deployed airbag in front of the A-pillars of the vehicle, the airbag, which is deployed from below the engine hood, includes a section or a chamber near the hood's hinges. As a result, the airbag is deployable above the hood along the entire width of the vehicle in front of the lower area of the windshield and the A-pillars. The airbag lateral ends of the airbag extend over the A-pillars in such a way that they are upwardly oriented and additionally fixed after deployment.

The invention relates to a motor vehicle safety device for protecting pedestrians and cyclists, in accordance with the precharacterizing clause of claim 1.

In addition to other safety devices for protecting pedestrians and cyclists (EP 0967 128 A2, DE 101 02 597 A1, DE 100 14 832 A1), a motor vehicle airbag system is known (EP 1 176 062 A2) having airbags which cover the region of the A pillars of the motor vehicle in the case of an accident with a pedestrian or cyclist. Said airbags are intended, in particular, to lessen the impact of the head onto the A pillar. Said airbags cover only a small part of the windshield, in order not to impede the vision of the driver, and are therefore narrow and unstable on account of the small volume. This results in the disadvantage that, in the event of an oblique impact of a person, said airbags can be pushed to the side by said person, with the result that the person collides with motor vehicle parts, in particular with the A pillar, and the intended protection cannot occur.

The invention is therefore based on the object of preventing the collision of a pedestrian or cyclist with the A pillar and adjoining parts of the motor vehicle, even in the event of an oblique collision, in the case of a safety device which also ensures good vision for the driver after the collision.

According to the invention, this is achieved in accordance with the features of claim 1.

In a motor vehicle safety device for protecting pedestrians and cyclists, having at least one airbag which is arranged under the engine hood, is connected to at least one gas generator, unfolds to protect a pedestrian or cyclist who strikes the vehicle and, in the process, initially lifts up the engine hood from the motor vehicle, at least at the location of the unfolding of the airbag, to such an extent that the airbag can unfold outwardly in a second phase, according to the invention, in the unfolded state, the airbag has two chambers under the engine hood in the region of the hinges of the engine hood. The airbag extends above the engine hood over the entire width of the motor vehicle in front of the lower region of the windshield and the A pillars of the motor vehicle, and the lateral ends of the airbag which, in particular, cover the A pillars point upward after the unfolding of said airbag and are additionally fixed. The unfolded airbag thus has a U shape.

The result of minimizing the displacement of the upwardly pointing ends which cover the rigid regions of the vehicle adjoining the engine hood is a high and reliable potential for protection. Additional fixing of the upwardly pointing ends ensures the protection against collision, in particular, with the A pillars, even in the event of an oblique collision, for example from the center of the windshield. The forces are introduced favorably by raising the engine hood over a wide area in the hinge region, which leads to relatively small deformations of the engine hood and thus to a reduction in oscillations.

The lateral ends can be fixed in different ways.

At least one intercepting strap or one tube-shaped airbag can thus be provided as a means for fixing the lateral ends of the airbag. Here, there is provision in one embodiment for the lateral ends of the airbag to be connected to one another by an intercepting strap or a tube-like airbag. There is provision in a further embodiment for the lateral ends of the airbag to be connected to the lower region of the airbag section which lies on the opposite vehicle side via intercepting straps which extend crosswise or via tube-like airbags.

There is provision in a third embodiment for the lateral ends of the airbag to be fixed by intercepting straps or tube-like airbags, the other ends of which are fastened to the motor vehicle, for example are connected to the central section of a module housing which is arranged below the engine hood.

There is provision in a further embodiment for each lateral end of the airbag to be fixed by two intercepting straps or two tube-like airbags which emerge from the outer side and the inner side of the respective lateral end.

The lateral ends can also be stabilized by providing reinforcements of the airbag in this region. At least one seam can be provided as reinforcement. However, at least one transparent airbag can also be provided as reinforcement. In one embodiment, at least one transparent reinforcement airbag is arranged between the lateral ends. In a further embodiment, at least one transparent woven fabric insert extends from each lateral end into the central region of the airbag.

A further possibility for supporting the lateral ends of the airbag consists in that a guide system which is connected to the airbag is provided in the region of the A pillars, with the aid of which guide system the lateral ends of the airbag are guided during its unfolding. The guide system preferably has a guide rail on each A pillar, on which guide rail a guide part which is connected to the airbag can be displaced during the unfolding of the airbag.

The at least one gas generator is connected to those sections or chambers of the airbag which lie below the engine hood in the unfolded state directly or indirectly via feed lines. This achieves the situation in which first the region of the airbag below the engine hood is filled and subsequently the airbag volume for the adjoining regions.

The airbag has at least one outflow opening for energy absorption by means of said airbag. In an airbag without an outflow opening, said airbag is subdivided into chambers by tucks or dividing walls for energy absorption by means of said airbag. The chambers are connected to one another in such a way that a volume can be displaced between them counter to a defined amount of resistance, that is to say the energy is absorbed by the work carried out to displace the volume between the chambers.

The invention is to be explained in exemplary embodiments using the drawings, in which:

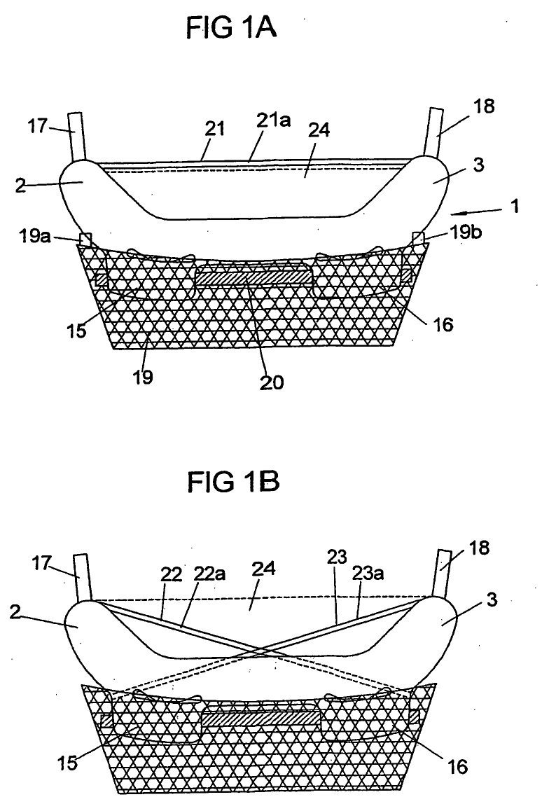

FIG. 1A shows a detail of the front view of a motor vehicle with an unfolded airbag and a first embodiment of the additional fixing means for the lateral ends of the unfolded airbag;

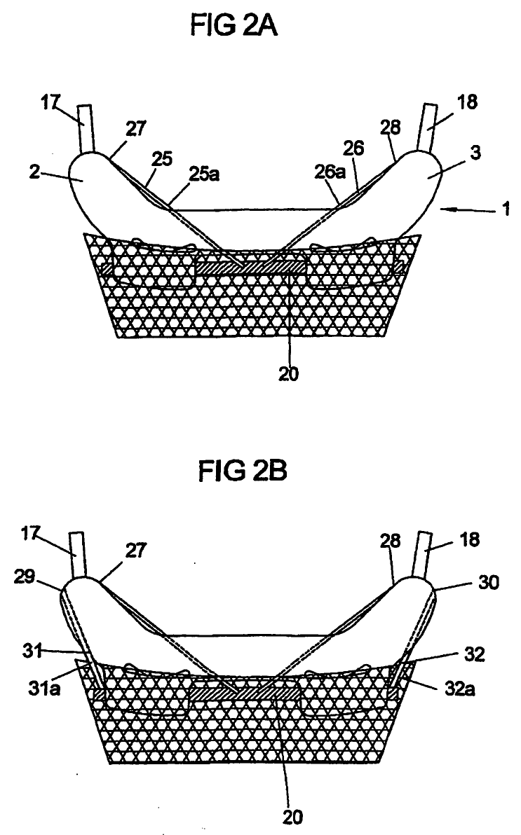

FIGS. 1B, 2A and 2B show the detail according to FIG. 1A with three further embodiments of the fixing means for the lateral ends of the unfolded airbag;

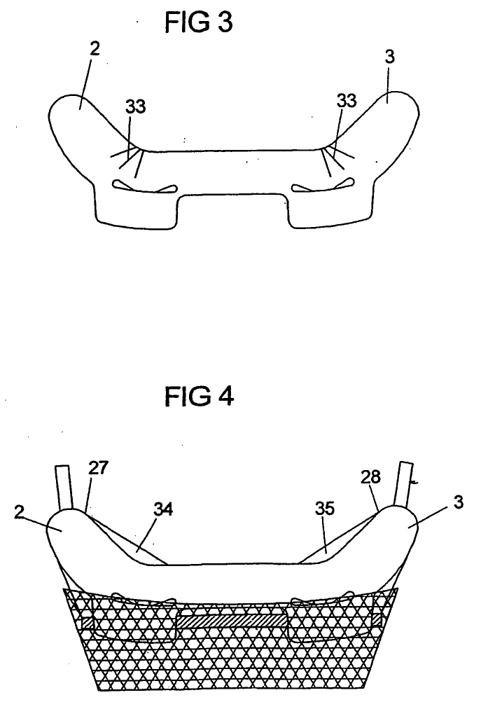

FIG. 3 shows an embodiment having stabilizing tucks in the woven fabric of the airbag;

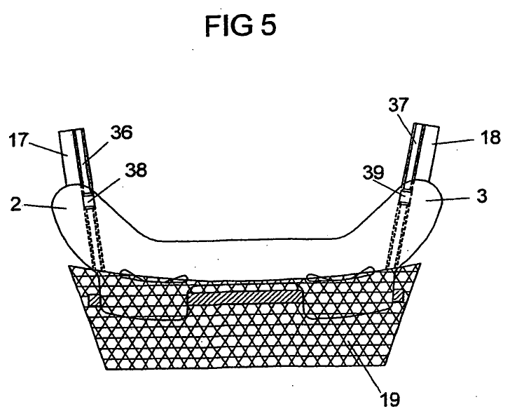

FIG. 4 shows an embodiment of the airbag having transparent woven fabric inserts;

FIG. 5 shows an embodiment having a guide system for the lateral ends of the airbag; and

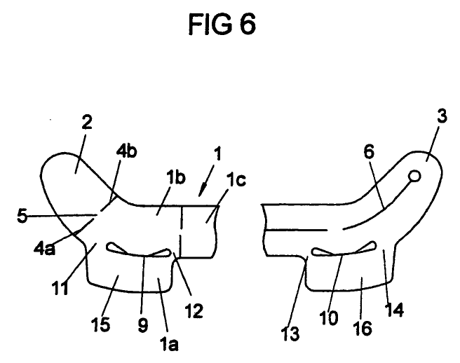

FIG. 6 shows an airbag in the unfolded state, said airbag having separate chambers below the engine hood.

The arrangement of the airbag 1 in the front region of a motor vehicle can be seen from FIGS. 1A, 1B, 2A, 2B, 4 and 5. The figures show the A pillars 17, 18 and the engine hood 19. An airbag is shown in an embodiment having chambers 15, 16 which lie below the engine hood 19 in the region of hinges 19a, 19b in the unfolded position shown. The airbag is assigned a module housing 20 which is arranged below the engine hood 19 and has at least one gas generator (not shown). The lateral ends 2, 3 of the airbag are additionally fixed in the embodiment of FIG. 1A by an intercepting strap 21 which extends between the ends 2, 3. As a result, the lateral yielding of the ends is prevented to a very large extent, even in the event of a lateral impact of a person. As the intercepting strap is narrow, the vision of the driver is barely impeded.

The same effect is achieved if, instead of the intercepting strap, a tube-shaped airbag 21a is provided, the diameter of which corresponds at least approximately to the width of the intercepting strap 21.

In the embodiment of FIG. 1B, two intercepting straps 22, 23 or corresponding tube-shaped airbags 22a, 23a which extend crosswise are provided. Here, one end of the intercepting strap 22 is connected to the lateral end 2, while the other end is connected in the region of the chamber 16 to the airbag section lying opposite. One end of the intercepting strap 23 is connected at the lateral end 3 of the airbag and the other end is connected in the region of the chamber 15 to the airbag section lying opposite.

In both embodiments, transparent airbags 24 for stabilizing the lateral ends 2, 3 could be provided instead of the intercepting straps or tube-shaped airbags of small diameter, the upper edge of which is indicated in each case by a dashed line in FIGS. 1A and 1B. Said transparent airbags impede the vision of the driver only to a minimum extent.

In the embodiment of FIG. 2A, intercepting straps 25, 26 or tube-shaped airbags 25a, 26a extend from the inner sides 27, 28 of the lateral ends 2, 3 of the airbag 1 to the central region of the module housing 20 and are connected to the latter there. In a further embodiment, as shown in FIG. 2B, intercepting straps 31, 32 or tube-shaped airbags 31a, 32a additionally also extend from the outer sides 29, 30 of the lateral ends 2, 3 to the edge regions of the module housing 20 and are connected to the latter there.

In the embodiment of FIG. 3, tucks 33 are provided for stabilizing the lateral ends 2, 3.

In the embodiment of FIG. 4, the lateral ends 2, 3 are provided by means of transparent woven fabric layers 34, 35 which extend obliquely downward from the inner sides 27, 28 of the lateral ends 2, 3 of the airbag and are connected to the airbag there in the central section of said airbag.

FIG. 5 shows an embodiment in which the lateral ends 2, 3 are connected to a guide system. In the region of the A pillars, said guide system has guide rails 36, 37 which extend as far as under the engine hood 19. Said guide rails are assigned guide parts 38, 39 which are connected to the lateral ends 2, 3 on the rear side of the latter. Said guide parts enclose the guide rails, so that they are not released from them and can move only in their longitudinal direction. During the unfolding of the airbag, the guide parts 38, 39 slide on the guide rails 36, 37 from the bottom to the top, until they have reached the end position which is shown in FIG. 5.

In all the embodiments shown, only the lower region of the windshield is covered by the airbag 1 as a consequence of the U shape of the unfolded airbag. Secondly, however, the region of the A pillars is covered stably by the airbag, with the result that, even in the event of an oblique impact of a person, displacement of the related airbag sections is prevented to a very large extent.

In the embodiment of FIG. 6, there are two chambers 15, 16 which are arranged in the region of the hinges 19a, 19b of the engine hood 19.

Two possibilities are shown in this figure for improving the dissipation of energy during the impact of a pedestrian or cyclist. The lateral end 2 is thus separated from the remaining region by tucks 4a, b, which leaves only a small opening 5 for the entry of gases into the lateral end, with the result that a separate chamber is formed. Although this opening allows rapid unfolding of the airbag on account of the high pressure of the gases, volume equalization to the remaining airbag region is delayed in the event of a collision of a person, that is to say resistance is generated to the displacement of the gas volume from the impact region as a result of the subdivision of the gas sack into chambers and appropriately dimensioned overflow regions. In this embodiment, the upper part 1b has a further chamber 1c which likewise serves to improve the dissipation of energy in the impact region.

The dissipation of energy is improved at the lateral end 3 by a tuck 6 which extends in the center thereof.

Tucks 9, 10 which leave only small openings 11 to 14 between the parts 1a and 1b are provided between those chambers 15, 16 of the airbag which remain below the engine hood after the unfolding of the airbag and the part 1b of the airbag. This achieves the situation in which the chambers 15, 16 which lift up the rear region of the engine hood (not shown here) unfold first of all, with the result that the part 1b can subsequently unfold above the engine hood in front of the lower region of the windshield and the A pillars.

1-19. (canceled)

20. A motor vehicle safety device for protecting pedestrians and cyclists comprising:
an airbag that is configured to be arranged under a hingedly connected hood of the vehicle; and
a gas generator connected to the airbag,
wherein, during inflation, the airbag is configured to lift at least a portion of the hood such that a section of the airbag can thereafter unfold onto an A-pillar and a lower portion of a windshield of the vehicle,
wherein, when unfolded, the airbag is configured to include a chamber located below the hood in the vicinity of one of the hinges of the hood, and a lateral end of the airbag, which is configured to cover the A-pillar, points upward, and
wherein the airbag section, which is configured to unfold onto the A-pillar, is fixed by a restraining member to prevent lateral displacement.

21. The safety device of claim 20, wherein the airbag is configured so that, when inflated, the airbag extends over the entire width of the vehicle into a position in front of both A-pillars.

22. The safety device of claim 20, wherein the restraining member is an intercepting strap.

23. The safety device of claim 20, wherein the restraining member is a tube-shaped airbag.

24. The safety device of claim 20, wherein the restraining member is an intercepting strap or a tube-like airbag that connects the lateral ends of the airbag together.

25. The safety device of claim 20,
wherein the restraining member includes a pair of intercepting straps or tube-like airbags,
wherein a first of the pair of intercepting straps or tube-like airbags connects a first lateral end of the airbag to a portion of the airbag that is located below the hood and on an opposite, second side of the vehicle, and
wherein a second of the pair of intercepting straps or tube-like airbags connects a second lateral end of the airbag to a portion of the airbag that is located below the hood and on an opposite, first side of the vehicle.

26. The safety device of claim 25, wherein the straps or tube-like airbags cross in a central portion of the vehicle.

27. The safety device of claim 20,
wherein the restraining member includes a pair of intercepting straps or tube-like airbags,
wherein a first end of a first of the pair of intercepting straps or tube-like airbags is connected to a first lateral end of the airbag and a second end of the first of the pair of intercepting straps or tube-like airbags is connected to the vehicle, and
wherein a first end of a second of the pair of intercepting straps or tube-like airbags is connected to a second lateral end of the airbag and a second end of the second of the pair of intercepting straps or tube-like airbags is connected to the vehicle.

28. The safety device of claim 27, wherein the second ends of the intercepting straps or tube-like airbags are connected to a central section of a module housing that is part of the vehicle and is located below the hood.

29. The safety device of claim 20,
wherein the restraining member includes two pairs of intercepting straps or tube-like airbags,
wherein a first of the two pairs of intercepting straps or tube-like airbags restrains inner and outer sides of a first lateral end of the airbag, and
wherein a second of the two pairs of intercepting straps or tube-like airbags restrains inner and outer sides of a second lateral end of the airbag.

30. The safety device of claim 20, further comprising a reinforcement mechanism provided in the vicinity of each of the lateral ends of the airbag.

31. The safety device of claim 30, wherein the reinforcement mechanism is a seam.

32. The safety device of claim 30, wherein the reinforcement mechanism is a transparent airbag provided between the lateral ends.

33. The safety device of claim 30, wherein the reinforcement mechanism is a transparent woven fabric insert extending from each lateral end into a central region of the airbag.

34. The safety device of claim 20, further comprising:
a guide system for guiding the lateral ends of the airbag during inflation,
wherein the guide system is connected to the airbag and is provided in the vicinity of the A-pillar.

35. The safety device of claim 34,
wherein the guide system has a guide rail on the A-pillar,
wherein a guide part is provided on the guide rail, and
wherein the guide part is connected to the airbag and is configured to be displaced during inflation of the airbag.

36. The safety device of claim 20, wherein the chamber is fluidly connected to a gas generator via feed lines.

37. The safety device of claim 20, wherein the airbag includes at least one outflow opening for energy absorption.

38. The safety device of claim 20, wherein the airbag is subdivided into at least four chambers by tucks and/or dividing walls.

39. The safety device of claim 38, wherein the airbag comprises an additional chamber connected to the first mentioned chamber and is configured so that a volume can be displaced between the two chambers for energy absorption.
